(19) United States
(12) Patent Application Publication
(10) Pub. No.: US 2015/0026986 A1
(43) Pub. Date: Jan. 29, 2015

(54) PAINT SCRAPER

(71) Applicant: INCO INNOVATION, Järfälla (SE)

(72) Inventor: Jan Berglund, Jarfalla (SE)

(21) Appl. No.: 14/381,629

(22) PCT Filed: Oct. 8, 2013
(86) PCT No.: PCT/SE2013/051182

§ 371 Date: Aug. 28, 2014

(30) Foreign Application Priority Data
Nov. 11, 2012 (SE) 1230121-4

(51) Int. Cl. B44D 3/16; A47L 13/08; B23D 79/08

(52) U.S. Cl. CPC B44D 3/164; B23D 79/08; A47L 13/08
USPC 30/172; 30/169; 30/350

(57) ABSTRACT

A paint scraper with blade which on its utmost part adjacent to the scraping edge has one or both sides coated with grains and/or powder of a material that is harder than the blade itself. The blade can be made of steel and the grain/powder material can be diamond, boron nitride, silicon carbide or similar.

### DESCRIPTION OF THE INVENTION

This invention relates to a paint scraper (1) which in its basic comprises a handle (2), one or two blades (3), and means (4,5,6) for mounting said blades. The blades are preferably made of spring steel making them both flexible and robust. The invention is characterized by the blades having their surfaces adjacent to the scraping edge coated with grain or powder of a material that is harder than the blade itself, such as diamond, boron nitride, silicon carbide or similar. For simplicity the phrase diamond will be used to cover all these materials hereafter. The big advantage with the diamond powder is that the edge of the blade becomes self sharpening in the sense that even after wear and tear there will still be one sharp edge since the powder and grains makes this side more resilient to wear. Another advantage is the increased friction between the diamonds and the painted surface, making the scraping more efficient. This friction is due to the fact that these very hard materials often has sharp edges and corners caused by there crystalline structure.

The paint scraper shown in the pictures contains two different kinds of blades even if the main claim only focuses on an ordinary scraper with only one blade. The intention is to show that the diamond powder can have different functions on different kinds of blade.

One type is a scraping type of blades as on a traditional scraper, shown active in FIG. 6. The pictures show a type made of bent spring steel, but the benefits is valid for all scraping blades with a sharp edge. The benefit here is to preserve the sharpness of that edge (8a′ or 8a″) since the powder coated side is more resilient to wear. Also the increased friction gives a better grip on the edges of the cracked paint.

The other blade type shown in the pictures is a cracking and grinding type, shown active in FIG. 5. Its job is to make cracks in the surface of the paint in the areas where the painted surface may look OK but has a poor adhesiveness to the painted surface. Here the diamond powder will increase the friction a lot. This makes the force from the tip of the blade (8b) not only be directed down due to the spring function but also gives the force a vector in the scraping direction due to the increased friction. In that way it is possible to crack the surface of the paint in the areas where it lacks good adhesiveness to the underlying surface. The remaining paint that is not removed will have its surface grinded and scratched, which is good since the new paint will get a better adhesiveness on a matt surface compare to a blank. In that way the old paint surface also is stripped from any grease or dirt that could be bad for adhesiveness of the new paint. It also grinds down the edges on the remaining paint so that there structure is not visible through the painted surface when the new paint is applied.

One problem with old paint is that it has different adhesiveness in different areas. In the areas with good bond it is easiest to leave the old paint in place but in areas with poor bond it is important that it is removed. If not removed, encapsulated air pockets might be a result, and even with a new layer of paint this area will be fragile and sensitive to mechanical stress or harsh weather. A conventional solid blade with no flexibility has a tendency to just slide over those surfaces without cracking the surface or scrape away anything since there is no edge to get a grip on. This fact often tempts you to use the corner of the blade which can harm the surface under the paint. For that reason it is beneficial if the blades are somewhat flexible the last part before the scraping edge in order to distribute the spring force throughout the whole blade, even if the surface is uneven. Uneven surfaces are exactly what you are working with when scraping, because some paint is removed and some is still there. Flexible blades, sharp edges and high friction are good combinations for removing old paint. The invention shows blades that uses increased friction to achieve scraping and clawing effects towards the painted surface. It also shows a way to use the hardness of the grains to preserve the sharpness of an edge, something that traditionally has been solved by using extra hard steel alloys in the blades and its scraping edges. With the use of diamond powder on the utmost part of the blade it is possible to use more flexible steel alloys giving the blades a flexibility that distributes the press force throughout the scraping edge.

The normal way to attach the diamond powder to the steel blade is by the use of an adhesive in combination with pressure, heat or electroplating. The adhesive can be ceramic, organic or metallic. On steel the use of Nickel as adhesive is common. The size of the grains has a standard issued by FEPA, Federation of European Producer of Abrasives. The size for this particular application is probably in the range 100-500 μm. It might be an advantage to use a mixture of different sizes so that the smaller grains will preserve the sharpness of the edge and the bigger grains is increasing the friction and acts like scratching claws.

The blades in the pictures are rotatable so that they can be rotated 180° when the blade is worn out on one side.

In an alternative embodiment the edge of the blade has been bent in a wave-like (13) shape. This increases the scratching force at certain areas since mainly the tip of the waves is in contact with the surface.

In another embodiment dimples (14) in the bends (15) are making the bends more resilient to the scratching forces that wants to straighten out the bends.

Yet another embodiment can have cuts giving the end of the blade a number of individually flexible fingers, as in BERGLUNDS patent SE536284, then the force is even easier distribute throughout the whole combined scraping edge.

### STATE OF THE ART AND PROBLEM TO BE SOLVED

Diamond powder or similar grains of hard material is often used to increase friction on files, sanding discs, cutting tools and on the tip of drills. The technique to apply the diamond powder on the steel has developed a lot during the last years and is still developing. It is often done with a combination of pressing or electroplating and the use of some kind of adhesive to fasten the grains. The grains abrasive ability is most important so each grain shall preferably have as many sharp edges as possible. In that way a high friction is achieved towards the surface to be processed and it also increases the grains bond to the adhesive making the grains fastening better.

The paint scrapers are normally designed with a handle that in one end has a blade made of a hard steel alloy with a sharp edge. The scraping edge is usually straight but there are variants where the edge is wave shaped in order to increase the pressure under the wave peaks. But these waves are static and lack flexibility to adjust to an uneven surface with varying adhesiveness of the paint.

After some time the scraping edge looses its sharpness. You can of course sharpen it or replace with a new blade but one problem is that the wear comes gradually and there is no clear signal that it is time to change the blade.

Another problem that is common for tools that are being used seldom like a paint scraper is to find the new blades when they are needed. A classical scenario is to spend half a day searching for the spare blades. Not unusually it ends up with a trip to town with the ambition to buy new blades, and then having a hard time finding the right type of blade, so you buy a new paint scraping system. In the present invention it is easier to see that the blade needs to be replaced because the diamond powder is worn out, and by rotating them 180° installing a pair of spare blades. There is also more edges to wear out when working with two types of blades, and that makes every scraping edge last longer. And it will be obvious that it is time to change blade because the friction will decline quickly.

Below is an example of problems when using an ordinary paint scraper with a rigid and stiff blade and scraping a house with standing wood panels:

Since the wood fibers are vertically oriented, the cracks in the paint are often also vertical. Then when scraping in a vertical direction, which feels natural, it is not unusual that the blade only glides over on top of the surface without removing the paint closest to the crack even though it lacks adhesiveness. The wood panel can also be a bit bent if it is a few years old making it even more difficult to get a good surface contact for the edge. Intuitively one is tempted to use the corner of the blade or start scraping horizontally over these areas. Both methods can be very harmful to the underlying wood, the use of the corner because it is very difficult to control the concentrated force and the horizontal scraping since it scrapes perpendicular to the fibers. These fibers are fragile since they have been exposed to rain and wind through the crack in the paint.

A blade that has some flexibility and is coated with diamond powder on the surfaces close to the edge distributes the force and enhances the friction all along the edge. Because of that, even vertically scraping movements will do the job in this example.

Another type of scraping tool is the steel brush which is a brush made of steel threads. This is a good tool to remove rust or other coatings but not very effective to remove paint, at least not with paint where the adhesiveness is varying from bad to good. This is due to the fact that it is missing both the cracking function and the scraping/peeling function mentioned earlier. The steel brush has more like grinding function that can work in areas with very bad adhesiveness and where the paint is already cracked. But it can be difficult to control the wearing of the underlying surface. For that reason it is best suitable to be used on metal.

Then there are grinding machines and sandpaper that also has a high friction towards the paint. They do not have a scraping edge as a paint scraper and because of that they have a tendency to get filled up with paint clogging all space between the grains with loss of friction as result. This is also a risk for the cracking type of blades of the invention, but here the scraper is normally held in a small angle so that the grains closest to the edge are doing most of the job. Since these grains are close to the edge they become automatically rinsed. When working with grinding machines with sandpaper a big part of the grinding surface is parallel with the surface so the old paint has nowhere to go. Also the speed of these machines could build up a heat making the paint even more prone to clogging.

### SUMMARY OF THE INVENTION

A paint scraper with blade(s) having there utmost part of one or both sides adjacent to the scraping edge(s) coated with grains or powder of a material harder then the blade itself. The powder and grains is typically made of diamond.

A paint scraper comprising flexible blades of spring steel that cracks the old paint surface in areas where the paint has lost its adhesiveness and at the same time is gentle to the underlying surface. The cracking function is enhanced by the flexibility of the blades and the high friction from the diamond powder coated on one side of the blade. Besides cracking, these blades also have the task to make the remaining old paints surface rugged, matted and left with smooth edges. This gives the new paint a better grip and an even surface when repainting.

A paint scraper comprising steel blade that is designed to scrape away loosely attached paint and to snap away paint that has bad adhesiveness to the underlying surface and an accessible edge. The sharpness of the scraping edge is preserved due to the diamond powder that has been coated on the utmost surface adjacent to the edge, on one or two sides of the blade. When the blade is worn down it is always the edge with diamond powder that is the last to be worn down and by that creating a sharp edge.

The scraping edges can be formed into a wave form (13) in order to give an increased pressure between the wave peaks and the paint. With dimples (14), the bends can be more robust and preserve there bends even after being used a long time.

The combination of these functions makes the paint scraper effective and gentle. Gentle both to the underlying surface but also to the user since it gives varying muscle usage when alternating between cracking and scraping blade type. The diamond powder gives an increased performance for these two functions.

### DESCRIPTION OF THE FIGURES

FIG. 1 Shows a 3D-view of the paint scraper
Paint scraper (1)
Handle (2)

FIG. 2 Shows an exploded 3D-view of the paint scraper (1)
Handle (2)
Rotatable blades (3)
Mounting details (4,5,6) for mounting the blades (3)

FIG. 3 Shows blade (3) with the surface of the utmost parts (7a,7b) of one side (3a) adjacent to the scraping edges (8a′,8b) coated with diamond powder (10) containing diamond grains (9)

FIG. 4 Shows blade (3) with the surface of the utmost part (7a) of one side (3b) adjacent to the scraping edge (8a″) coated with diamond powder (10) containing diamond grains (9)

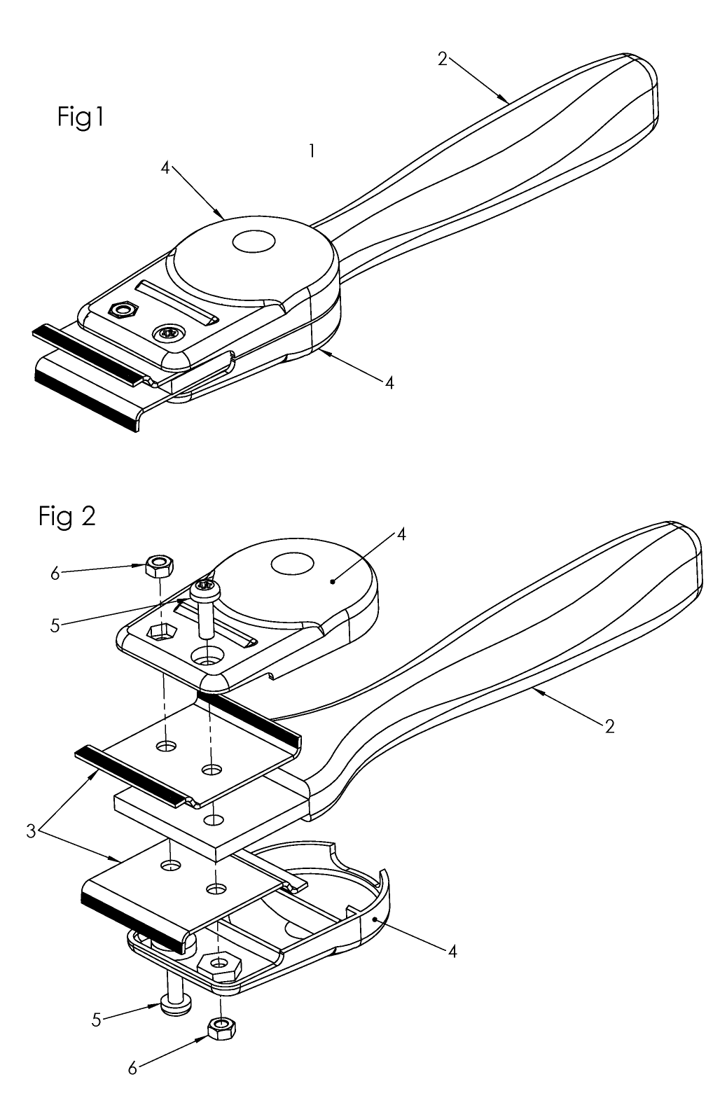

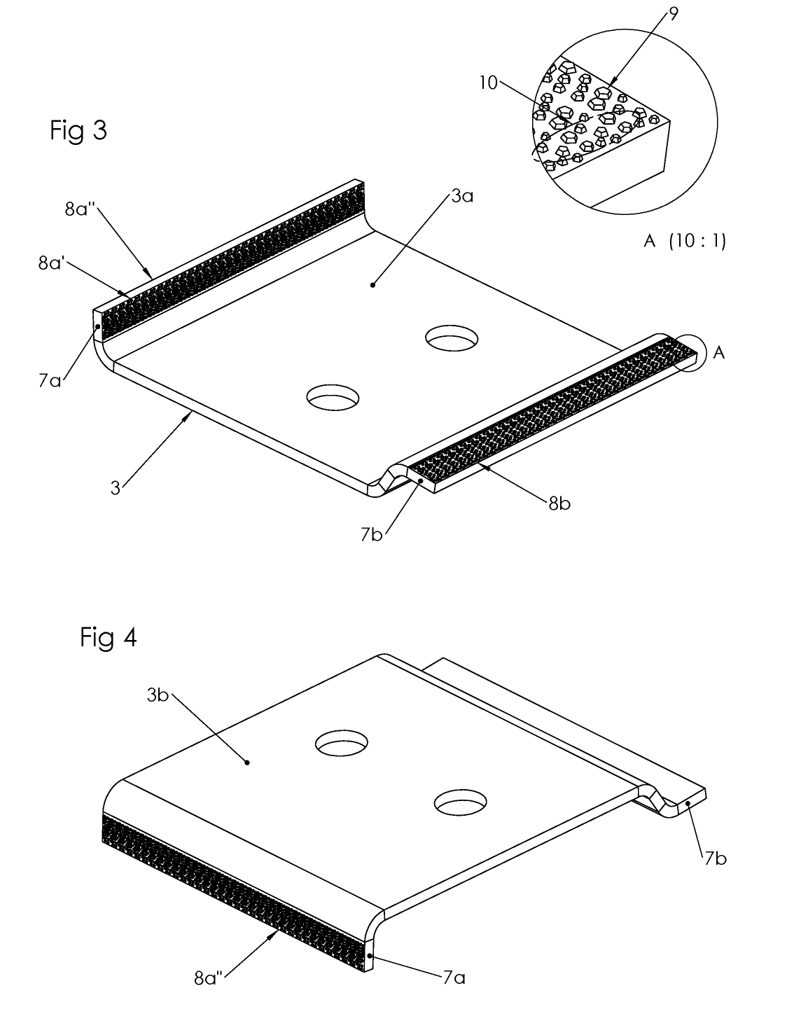

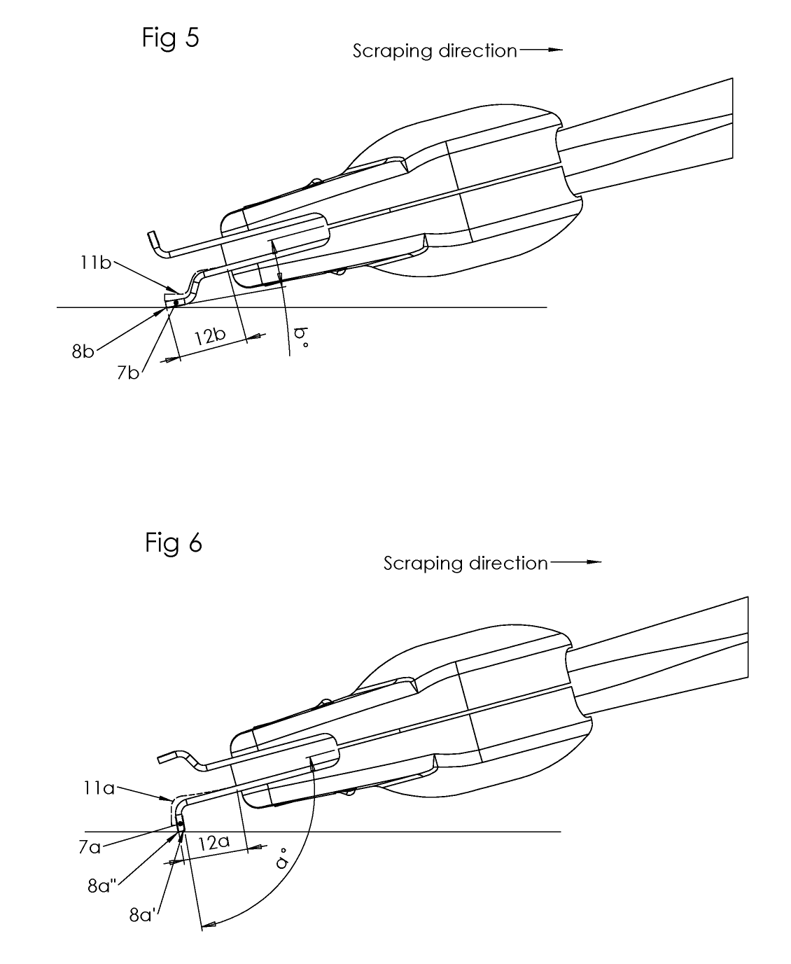

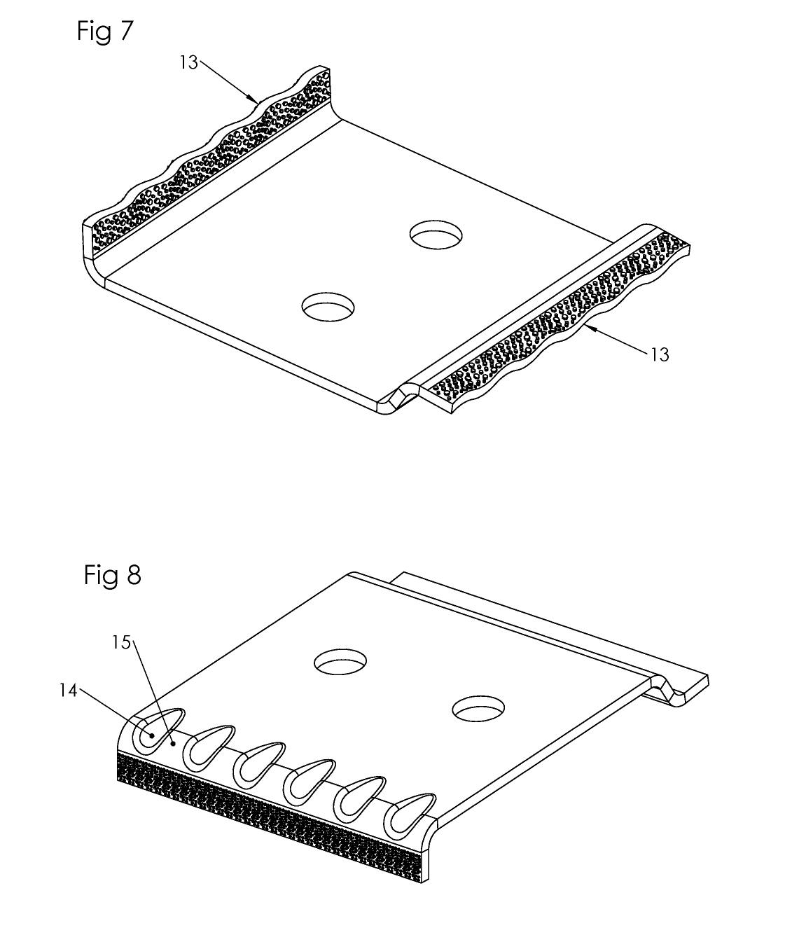

FIG. 5 Shows a cropped view from the side of the paint scraper with the cracking side of the blade in an active position
Detached part (12b) of blade (3)
Flexibility (11b) of blade (3)
The utmost part (7b) before the scraping edge (8b)
The scraping edge (8b) of the cracking blade side and the angle b°

FIG. 6 Shows a cropped view from the side of the paint scraper with the scraping side of the blade in an active position
Detached part (12a) of blade (3)
Flexibility (11a) of blade (3)
The utmost part (7a) before the scraping edges (8a′,8a″)
The scraping edges (8a′,8a″) for the scraping side and the angle a°

FIG. 7 Shows a blade with wave shaped dimples (13) on the scraping edge

FIG. 8 Shows a blade with dimples (14) to strengthen the bends (15)

1. A paint scraper comprising a handle, at least one blade and means for mounting said blade on said handle, said paint scraper is characterized in that said blade on at least one of the two sides has the surface on the utmost part adjacent to the scraping edge coated with grains and/or powder of a material harder than the blade itself.

2. A paint scraper according to claim 1 where the blade is made of spring steel.

3. A paint scraper according to claim 1 where the grains and/or powder is made of diamond, boron nitride, silicon carbide or similar.

4. A paint scraper according to claim 1 where the powder coated surface on the utmost part of the blade in a side view projection is mainly perpendicular to the longitudinal axis of the handle, that is, the angle a is close to 90°.

5. A paint scraper according to claim 1 where the powder coated surface on the utmost part of the blade in a side view projection is mainly parallel with the longitudinal axis of the handle, that is, the angle b is close to 0°.

6. A paint scraper according to claim 1 with one blades scraping edges in an active position on one side and another blades scraping edge in an active position on the other side of the longitudinal axis of the handle.

7. A paint scraper according to claim 1 with holders constituting a front handle and encapsulating the blades non active scraping edges.

8. A paint scraper according to claim 1 with blades that are flexible in their detached parts.

9. A paint scraper according to claim 1 with blades being rotatable for alternative mounting.

10. A paint scraper according to claim 1 with a blade having dimples for a wave shaped scraping edge.

11. A paint scraper according to claim 1 with a blade having dimples for more robust bends.

12. A blade intended for a paint scraper, said blade is characterized in that at least one of the two sides has the surface on the utmost part adjacent to the scraping edge coated with grains and/or powder of a material harder than the blade itself.

13. A blade according to claim 12 where the blade is made of spring steel.

14. A blade according to claim 12 where the grains and/or powder is made of diamond, boron nitride, silicon carbide or similar.

15. A paint scraper, comprising:
a first blade coupled to a handle, the first blade having a first side and a second side, wherein at least one of the first and second sides comprises grains and/or powder of a coating material harder than a composition of the first blade.

16. The paint scraper of claim 15, wherein the coating material is selected from the group consisting of diamond, boron nitride, and silicon carbide.

17. The paint scraper of claim 15, wherein the first side defines a first surface parallel with a blade surface, wherein the second side defines a second surface perpendicular with the blade surface, and wherein the first surface and the second surface are each at least partially coated with the grains and/or powder.

18. The paint scraper of claim 15, wherein at least one of the first side and the second side terminates at a scraper edge, wherein the scraper edge has a configuration selected from the group consisting of a straight edge and a dimpled edge.

19. The paint scraper of claim 15, further comprising:
a second blade coupled to the handle, the second blade having opposing sides comprising additional grains and/or powder of the coating material.

20. The paint scraper of claim 15, wherein the first side has a curvature, and wherein at least one dimple is positioned along the curvature.
